(19) United States
(12) Patent Application Publication
(10) Pub. No.: US 2011/0115904 A1
(43) Pub. Date: May 19, 2011

(54) OBJECT-DETECTING SYSTEM

(75) Inventors: Li Te-Yuan, Hualien County (TW); Tsai Hua-Chun, Taipei (TW); Liao Yu-Wei, Taipei City (TW); Shyu Der-Rong, Hsinchu County (TW)

(73) Assignee: QISDA CORPORATION, Taoyuan County (TW)

(21) Appl. No.: 12/948,743

(22) Filed: Nov. 17, 2010

(30) Foreign Application Priority Data
Nov. 18, 2009 (TW) 098139111

(51) Int. Cl. H04N 7/18; G06K 9/00

(52) U.S. Cl. 348/135; 382/103; 348/E07.085

(57) ABSTRACT

The invention discloses an object-detecting system including a periphery member, a first reflection device, a first image-capturing unit, and a data processing module. The periphery member thereon defines an indication space and an indication plane in the indication space for an object to indicate a target position. There is a contrast relation between the periphery member and the object. The first reflection device is disposed on the periphery member. The first image-capturing unit captures a first image of the indication space near a part of the periphery member and also captures a first reflected image reflected by the first reflection device of the indication space near a part of the periphery. The data processing module is electrically connected to the first image-capturing unit and processes the first image and the first reflected image so as to determine object information relative to the object in the indication space.

### BACKGROUND OF THE INVENTION

1. Field of the Invention

The present invention relates to an object-detecting system. In particular, the present invention relates to an object-detecting system for increasing accuracy of detection.

2. Description of the Prior Art

With the progressive maturity of relative techniques, touch control systems with large size screens and multi-touch features are becoming one mainstream of electronic products. At present, optical touch control systems, compared with other touch control technologies such as resistive, capacitive, supersonic or projector systems, have the advantages of low costs and feasibility.

Please refer to FIG. 1. FIG. 1 shows a traditional optical touch control system 1. The traditional optical touch control system 1 has the disadvantage that when there are two or more touch points on the screen 10, the system would detect them mistakenly. As shown in FIG. 1, when a user touches both the points Pa and Pb on the touch screen 10 by an indicating object, the indicating object shades the light emitted from the light source of the touch control system 1 and four shadow images (D1′˜D4′) respectively formed on the left, right, and lower edges of the touch control system 1 are generated. The shadow images will be captured by two image capturing units 12. After that, the touch control system 1 calculates the coordinate of the indicated position according to the four shadow images. A real solution and an imaginary solution are generated. The real solution includes the coordinates of the real indicated points Pa and Pb. The imaginary solution includes the coordinates of the points Pa′ and Pb′ that are not indicated by the user. The touch control system 1 may provide wrong detected results because of the existence of the imaginary solution.

Moreover, traditional optical touch control systems have some drawbacks. For example, if two or more points are indicated, when two of the indicated points and the image capturing unit are in a line, the shadow of the indication object corresponding to the indicated point closer to the image capturing unit may cover the shadow of the indication object corresponding to the other indicated point. It will be difficult to determine the position of the shadow corresponding to the other indicated point. Therefore, the system would misjudge the position of the indicated point.

U.S. Pat. No. 7,460,110 discloses a high resolution optical touch control system. In FIG. 7 of the patent, the pointer P on the touch panel is a light source radiate around; the upper side and the left side are non-reflective bezels; the right side is a turning prism assembly 72 and the lower side is a mirror 92. The function of the turning prism assembly 72 is parallel guiding the light above the touch panel into the waveguide under the touch panel. The system has some disadvantages: 1) the corner of the touch panel needs to be made rounded to avoid the refraction as the light access the waveguide, and the rounded corner is harder to make; 2) in the non-air waveguide, the optical path is long and the optical decline is worse; 3) the center of the turning prism assembly 72 should be precisely aligned with the surface extension lines of the touch panel, and it's not easy for assembly; and 4) it requires radiation light source P, minor 92 and turning prism assembly 72 altogether to achieve the goal, which is complicated.

Therefore, an object of the present invention is to improve the traditional optical touch control system, so as to further enhance the usage and popularity of the optical touch control system.

### SUMMARY OF THE INVENTION

A scope of the invention is to provide an object-detecting system.

One embodiment according to the invention is an object-detecting system including a periphery member, a first reflection device, a first image-capturing unit, a first point light source, and a data processing module. The periphery member thereon defines an indication space and an indication plane in the indication space for an object to indicate a target position. There is a contrast relation between the periphery member and the object. The indication plane has a first edge, a second edge, a third edge and a fourth edge. The first edge and the fourth edge form a first corner; the third edge and the fourth edge form the second edge; and the fourth edge is opposite to the second edge. The first reflection device is disposed on the second edge and on the periphery member. The first image-capturing unit is disposed adjacent to the first corner. The first image-capturing unit defines a first image-capturing point, captures a first image of the indication space near a part of the periphery member corresponding to the second and third edges, and also captures a first reflected image reflected by the first reflection device of the indication space near a part of the periphery corresponding to the third and fourth edges. The first point light source is disposed adjacent to the first image-capturing unit for lighting the indication space. The data processing module is electrically connected to the first image-capturing unit and processes the first image and the first reflected image so as to determine object information relative to the object in the indication space.

In another embodiment according to the invention, the object-detecting system includes a periphery member, a first reflection device, a first image-capturing unit, and a data processing module.

The periphery member defines an indication space and an indication plane in the indication space for an object to indicate a target position, and includes a line light source for lighting the indication space. The indication plane has a first edge, a second edge, a third edge and a fourth edge. The first edge and the fourth edge form a first corner; the third edge and the fourth edge form the second edge; and the fourth edge is opposite to the second edge. The first reflection device is disposed on the second edge. The first image-capturing unit is disposed adjacent to the first corner. The first image-capturing unit defines a first image-capturing point, captures a first image of the indication space near a part of the periphery member corresponding to the second and third edges, and also captures a first reflected image reflected by the first reflection device of the indication space near a part of the periphery corresponding to the third and fourth edges. The data processing module is electrically connected to the first image-capturing unit and processes the first image and the first reflected image so as to determine object information relative to the object in the indication space.

The advantage and spirit of the invention may be understood by the following recitations together with the appended drawings.

### BRIEF DESCRIPTION OF THE APPENDED DRAWINGS

FIG. 1 shows a traditional optical touch control system.

FIG. 2A is a schematic representation of the object-detecting system in an embodiment according to the invention.

FIG. 2B is a schematic representation of the object-detecting system in another embodiment according to the invention.

FIG. 3A and FIG. 3B are cross-sectional views of the object-detecting system of FIG. 2A in other embodiments.

FIG. 4A and FIG. 4B are cross-sectional views of the object-detecting system of FIG. 2B in other embodiments.

FIG. 5A shows how the object images are formed in the object-detecting system in an embodiment according to the invention.

FIG. 5B shows a partial sectional view of a part of the periphery member corresponding to the second edge in FIG. 5A.

FIG. 6 shows the first image and the first reflected image captured by the first image-capturing unit in FIG. 5A.

FIG. 7 shows how the object images are formed in the object-detecting system in another embodiment according to the invention.

FIG. 8 shows the first image and the first reflected image captured by the first image-capturing unit in FIG. 7.

FIG. 9 shows how the object images are formed in the object-detecting system in an embodiment according to the invention.

FIG. 10 shows the first image and the first reflected image captured by the first image-capturing unit in FIG. 9.

FIG. 11 shows how the object-detecting system detects the target position of the object in an embodiment according to the invention.

FIG. 12 shows how the object-detecting system detects the target positions of two objects in an embodiment according to the invention.

FIG. 13 shows how the object-detecting system detects the shape and the area of the object projected on the indication plane in an embodiment according to the invention.

FIG. 14 is a schematic presentation of the first image and the first reflected image divided into a plurality of first sub-images and a plurality of first reflected sub-images in an embodiment according to the invention.

FIG. 15 shows how the object-detecting system detects the three-dimensional shape and the volume of the object in the indication space according to the embodiment of FIG. 14.

FIG. 16 shows how the object-detecting system detects the three-dimensional shape and the volume of the object in the indication space in an embodiment according to the invention.

FIG. 17 shows a cross-sectional view of the object-detecting system in FIG. 2B in another embodiment according to the invention.

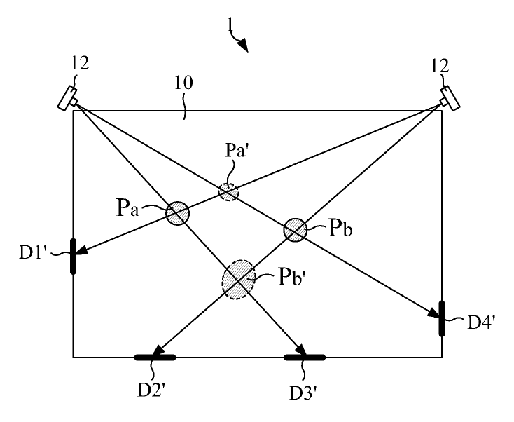

### DETAILED DESCRIPTION OF THE INVENTION

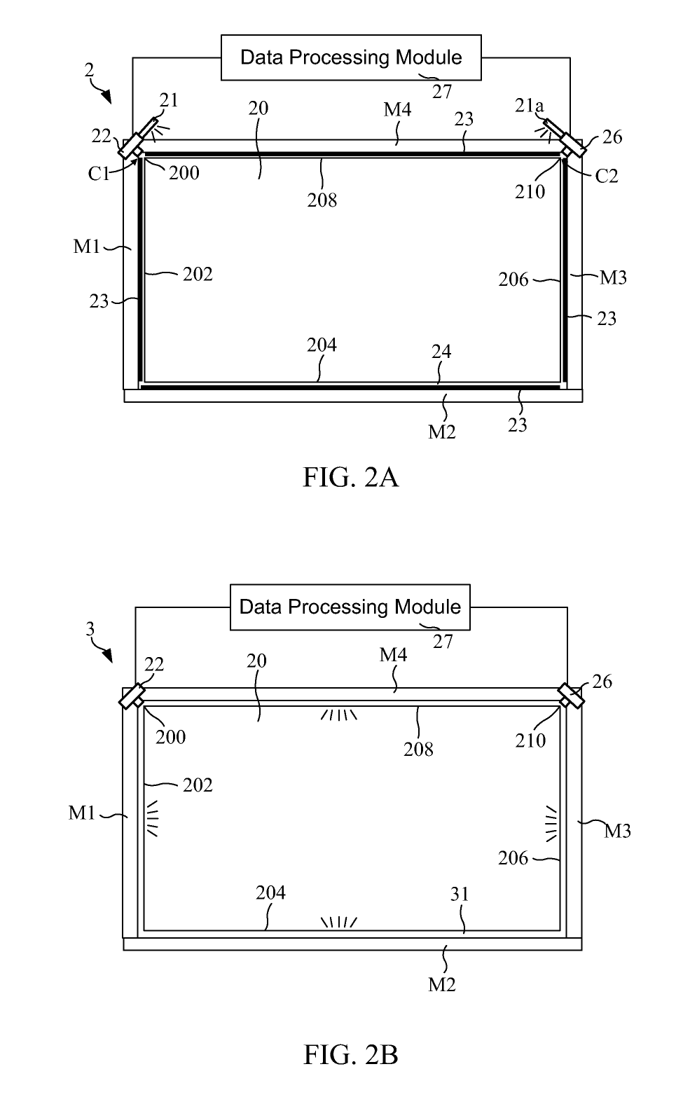

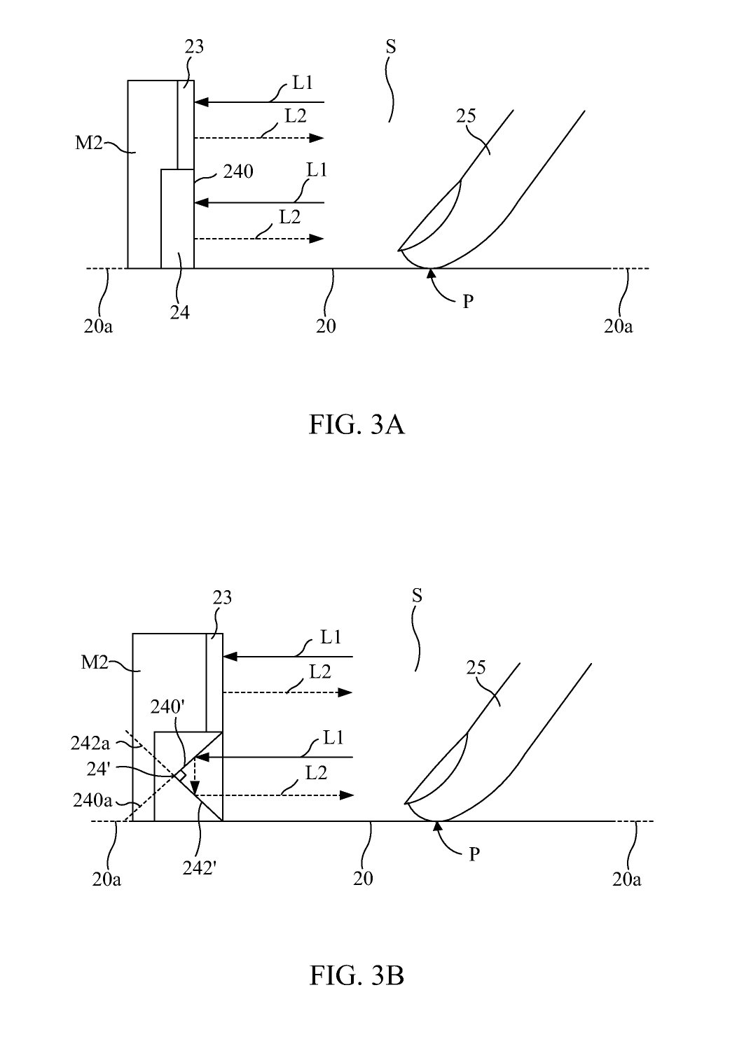

Please refer to FIG. 2A, FIG. 3A and FIG. 3B. FIG. 2A is a schematic representation of the object-detecting system 2 in an embodiment according to the invention. FIG. 3A and FIG. 3B are cross-sectional views of the object-detecting system 2 in FIG. 2A in other embodiments according to the invention.

The object-detecting system 2 includes periphery members M1˜M4, a first reflection device 24, a second reflection device 23, a first image-capturing unit 22, a second image-capturing unit 26, a first point light source 21, a second point light source 21a, and a data processing module 27. The periphery members M1˜M4 thereon define an indication space S and an indication plane 20 in the indication space S for an object 25 to indicate a target position P. There is a contrast relation between the periphery members M1˜M4 and the object 25. In the embodiment, the indication space S is defined as the space substantially surrounded by the periphery members M1˜M4, and the height of the indication space S is approximately the same as that of the periphery members M1˜M4.

The indication plane 20 has a first edge 202, a second edge 204, a third edge 206, and a fourth edge 208. The first edge 202 and the fourth edge 208 form a first corner 200. The third edge 206 and the fourth edge 208 form the second corner 210. The fourth edge 208 is opposite to the second edge 204. The first reflection device 24 is disposed on the second edge 204 and on the periphery member M2.

The first image-capturing unit 22 is disposed adjacent to the first corner 200. The first image-capturing unit 22 defines a first image-capturing point C1. The first image-capturing unit 22 captures a first image of the indication space S, especially the regions near the periphery members M2 and M3 corresponding to the second edge 204 and the third edge 206. The first image-capturing unit 22 also captures a first reflected image of the indication space S, especially the regions near the periphery members M3 and M4 corresponding to the third edge 203 and fourth edge 204. The first reflected image is formed by the first reflection device 24. The second image-capturing unit 26 is disposed adjacent to the second corner 210. The second image-capturing unit 26 defines a second image-capturing point C2. The second image-capturing unit 26 captures a second image of the indication space S, especially the regions near the periphery members M1 and M2 corresponding to the first edge 202 and second edge 204. The second image-capturing unit 26 also captures a second reflected image of the indication space S, especially the regions near the periphery members M1 and M4 corresponding to the first edge 202 and fourth edge 208. The second reflected image is formed by the first reflection device 24.

The first point light source 21 is disposed adjacent to the first image-capturing unit 22. The second point light source 21a is disposed adjacent to the second image-capturing unit 26. The first point light source 21 and the second point light source 21a illuminate the indication space S. The data processing module 27 is electrically connected to the first image-capturing unit 22 and the second image-capturing unit 26. Based on at least two among the first image, the first reflected image, the second image, and the second reflected image, the data processing module 27 determines the object information in the indication space S.

Practically, the indication plane 20 can be a virtual plane, a display panel, or a plane on another object. The indication plane 20 is used for the user to indicate a target position P thereon. The object 25 can be a finger of the user or other indicator such as a stylus used for indicating the target position P on the indication plane 20. The object information can include a relative position of the target position P of the object 25 relative to the indication plane 20, an object shape and/or an object area of the object 25 projected on the indication plane 20, and an object three-dimensional shape and/or an object volume of the object 25 in the indication space S.

The periphery members M1˜M4 can be separate members or integrated as a single member. In the embodiment, the indication plane 20 defines an extension plane 20a, and the periphery members M1˜M4 are separately disposed on the extension plane 20a. But in actual applications, there can be less than four members disposed on one or more edges of the indication plane 20, as long as the first reflection device 24 can be disposed thereon.

As shown in FIG. 3A, in an embodiment, the first reflection device 24 can be a plane minor having a reflection plane 240. In another embodiment, as shown in FIG. 3B, The first reflection device 24′ includes a first reflection plane 240′ and a second reflection plane 242′, and the first reflection plane 240′ and the second reflection plane 242′ are substantially orthogonal and facing to the indication space S. The first reflection plane 240′ defines a first extension plane 240a (dotted line extended from the first reflection plane 240′); the second reflection plane 242′ defines a second extension plane 242a (dotted line extended from the second reflection plane 242′), and the first extension plane 240a and the second extension plane 242a substantially intersect with the extension plane 20a at a 45 degree angle respectively. Practically, the first reflection device 24′ can be a prism.

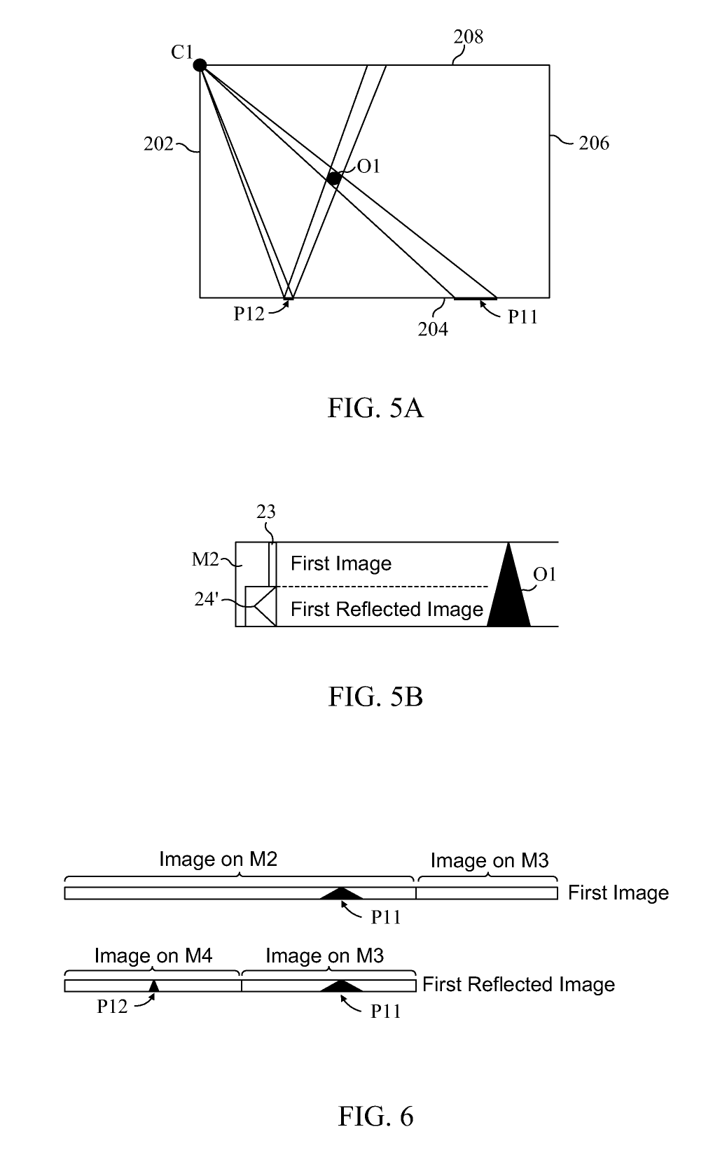

It is worth noting that the first reflection plane 240′ and the second reflection plane 242′ are substantially orthogonal so that the incident light L1 toward the first reflection device 24′ and the reflected light L2 reflected by the first reflection device 24′ are substantially parallel, as shown in FIG. 3B. As shown in FIG. 3B and FIG. 5A, the incident light L1 and the reflected light L2 are symmetrical relative to the first reflection device 24′. (See more in detailed in description about FIG. 5A.) Therefore, the reflection device 24′ has the advantage of huge tolerance for assembly. Even the first reflection device 24′ is a bit rotated, as seen in FIG. 3B, the incident light and the reflected light of the first reflection device 24′ can be substantially parallel. It is worth noting that the first reflection device can be another type besides a plane mirror and a prism.

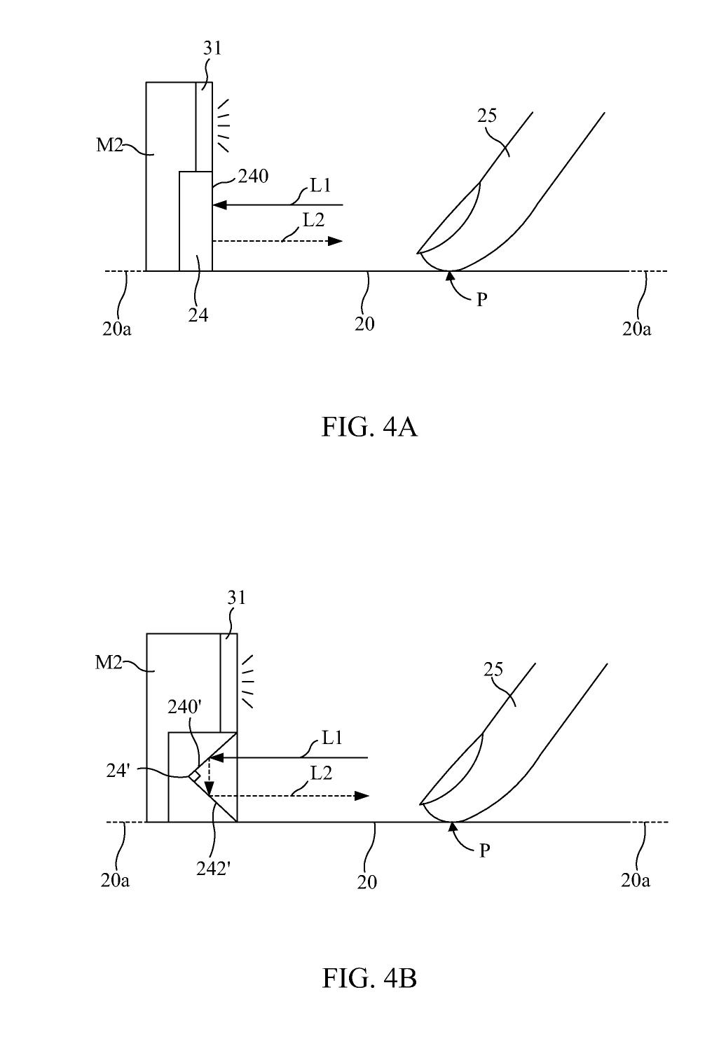

Furthermore, please refer to FIG. 2B, FIG. 4A and FIG. 4B. FIG. 2B is a schematic representation of the object-detecting system 3 according to another embodiment of the invention. FIG. 4A and FIG. 4B are cross-sectional views of the object-detecting system 3 of FIG. 2B in different embodiments. The difference between the embodiments of FIG. 2B and FIG. 2A is that the light source of object-detecting system 2 of FIG. 2A is point light sources 21 and 21a disposed adjacent to the first image-capturing unit 22 and the second image-capturing unit 26 while the light source of object-detecting system 3 of FIG. 2B is a line light sources 31 belonging to part of the periphery members M1˜M4. In the embodiment, as shown in FIG. 4A and FIG. 4B, the first reflection device 24 or 24′ is disposed in between the extension plane 20a and the line light source 31. And in different embodiment, the line light source 31 can also be disposed in between the extension plane 20a and the first reflection device 24 or 24′.

In aforesaid embodiment, as long as the periphery members M1˜M2 have light reflection feature so that there is a contrast relation between the periphery members M1˜M2 and the object 25, the brightness difference between the periphery members M1˜M4 as a background and the object 25 as a foreground can be distinguished. Then the object-detecting system 2 does not need additional second reflection device 23 disposed on the periphery members M1˜M4 since its function has already been performed. In that situation, the object 25 appears on the periphery members M1˜M4, that is, the background shown in the first image and the first reflected image is the periphery members M1˜M4. However, we can also additionally dispose the second reflection device 23 in the object-detecting system 2 to enhance the light reflection in the indication space S.

The embodiment of additional second reflection device 23 disposed in the object-detecting system 2 is described as below. Please refer to FIG. 2A, FIG. 3A and FIG. 3B, the second reflection device 23 is disposed on the periphery members M1, M2, M3, and M4 on the first edge, the second edge, the third edge, and the fourth edge. As the light emitted from the first and second point light sources 21 and 21a disposed adjacent to the first and second image-capturing units 22 and 26 travels toward the second reflection device 23, the second reflection device 23 reflects the incident light. As the second reflection device 23 is disposed, the background shown in the first image and the first reflected image is the second reflection device 23. In an embodiment, the second reflection device 23 reflects an incident light L1 having a direction of travel and make the reflected light L2 travel along a direction substantially opposite and parallel to the direction of travel of light L1. In practice, second reflection device 23 can be a retro reflector. In the embodiment, as shown in FIG. 3A and FIG. 3B, the first reflection device 24 or 24′ can be disposed in between the extension plane 20a and the second reflection device 23. In another embodiment, the second reflection device 23 can also be disposed in between the extension plane 20a and the first reflection device 24 or 24′.

As the second reflection device 23 is disposed around the four edges of the indication plane 20, the object-detecting system 2 can only dispose the periphery member M2 on the second edge 204 for supporting the second reflection device 23 and the first reflection device 24 or 24′, without disposing the other periphery members M1, M3 and M4.

FIG. 5A shows how the object images are formed in the object-detecting system 2 in FIG. 2A in one embodiment according to the invention. To make FIG. 5A easy to understand, it only shows paths related to imaging of an object O1 in connection with the object O1 and the first image-capturing unit 22, and the first image-capturing unit 22 is represented by the first image-capturing point C1. The light path of the second image-capturing unit 26 is similar to that of the first image-capturing unit 22 without showing herein. FIG. 5B shows a partial sectional view of a part of the periphery member M2 corresponding to the second edge 204 in FIG. 5A, wherein the second reflection device 23 governs the first image; the first reflection device 24′ governs the first reflected image; and the object O1 is represented as a cone. FIG. 6 shows the first image and the first reflected image captured by the first image-capturing unit 22 of FIG. 5A, wherein the range of first image and the first reflected image is as shown in FIG. 5B.

Please refer to FIG. 2A, FIG. 5A and FIG. 6. Before the object O1 enters the indication space S, the first image directly captured by the first image-capturing unit 22 shows the periphery member M2 on the second edge 204 and the periphery member M3 on the third edge 206, and the first reflected image captured by the first image-capturing unit 22 through the first reflection device 24 or 24′ shows the periphery member M3 on the third edge 206 and the periphery member M4 on the fourth edge 208.

As the object O1 enters the indication space S, the first image directly captured by the first image-capturing unit 22 shows the object O1 in the indication space S imaging on the periphery member M2 on the second edge 204 and on the periphery member M3 on the third edge 206, and the first reflected image captured by the first image-capturing unit 22 through the first reflection device 24 or 24′ shows the object O1 in the indication space S imaging on the periphery member M3 on the third edge 206 and the periphery member M4 on the fourth edge 208.

In the embodiment, because of the position of the object O1 as shown in FIG. 6, in the first image, the object O1 forms an image P11 on the periphery member M2 on the second edge 204. And in the first reflected image, besides the image P11 is reflected by the first reflection device 24 or 24′ on the second edge 204 and then imaged on the periphery member M3 on the third edge 206, the object O1 is also reflected by the first reflection device 24 or 24′ on the second edge 204 and then imaged as image P12 on the periphery member M4 on the fourth edge 208

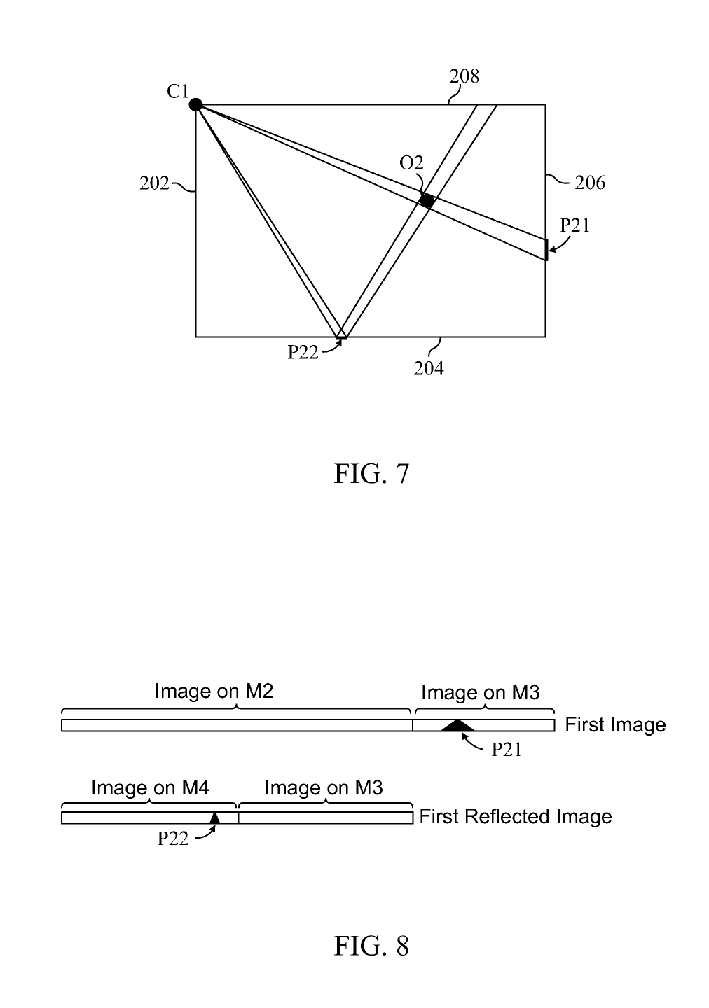

FIG. 7 illustrates how the object images are formed in the object-detecting system 2 in another embodiment according to the invention. In this figure, only the optical paths related to the object O2 and the first image-capturing unit 22 are shown. The first image-capturing unit 22 is represented by a first image-capturing point C1 in this figure. The optical paths related to the second image-capturing unit 26 are similar and not shown. FIG. 8 shows the first image and the first reflected image captured by the first image-capturing unit 22. The ranges of the first image and the first reflected image are shown in FIG. 5B.

In this embodiment, as shown in FIG. 8, the object O2 forms an image P21 on the periphery member M3 in the first image. In the first reflected image, the object O2 forms an image P22 on the periphery member M4 located at the fourth edge 208 because of the reflection of the first reflection device 24 or 24′ located at the second edge 204.

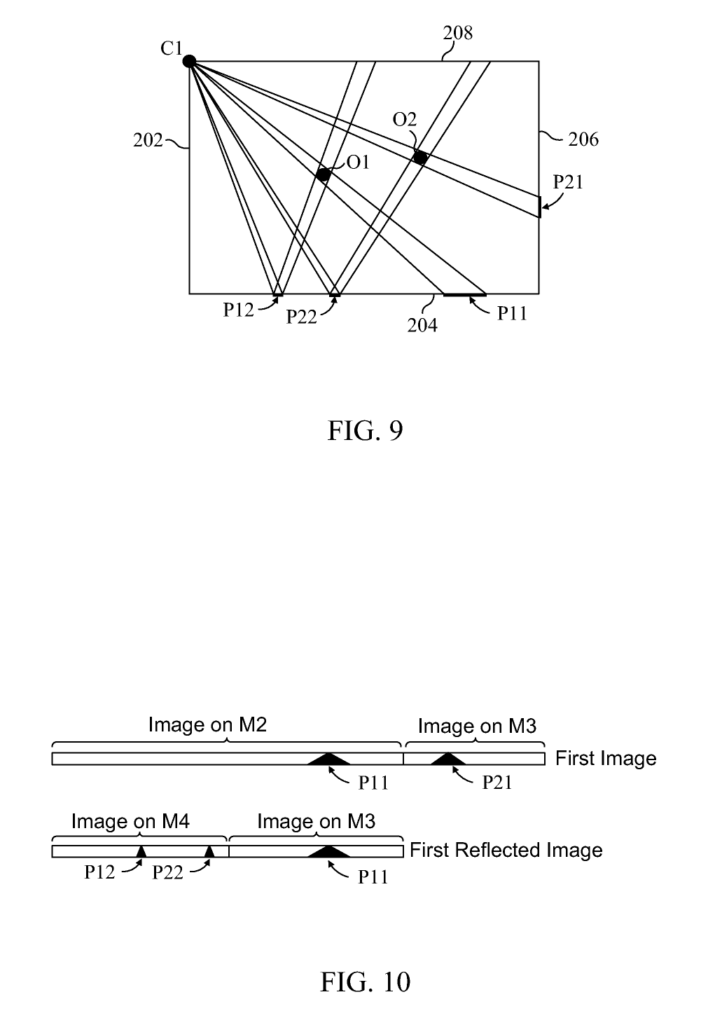

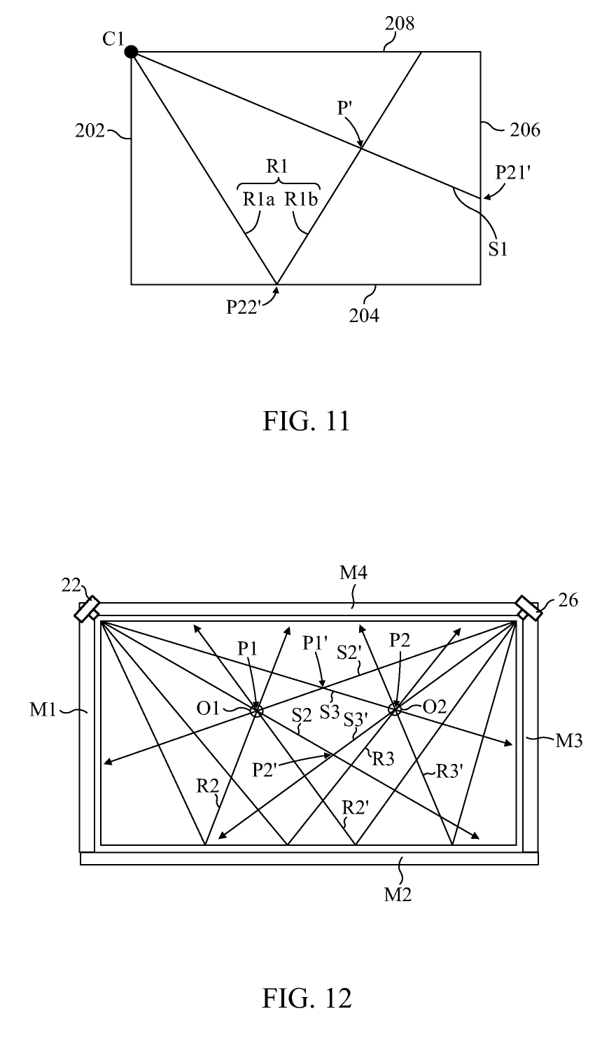

Combining the descriptions of the two embodiments, if the object O1 and object O2 co-exist, how the object images are formed in the object-detecting system 2 is illustrated in FIG. 9. FIG. 10 shows the corresponding first image and first reflected image captured by the first image-capturing unit 22.

The object information can include the target position of the object 25 relative to the indication plane 20, the object shape/area of the object 25 projected on the indication plane 20, and the object three-dimensional shape and/or volume of the object 25 in the indication space S. How these position, shape, area, or volume of the object 25 can be determined in the object-detecting system 2 according to the invention is described below.

Please refer to FIG. 8 and FIG. 11. How the object-detecting system 2 in one embodiment according to the invention detects the relative position of the object O2 relative to the indication plane 20 is explained based on the two figures. Based on the object image of object O2 in the first image, the data processing module 27 determines a first object point P21′ on the second edge 204 and/or the third edge 206. Based on the object image of object O2 in the first reflected image, the data processing module 27 determines a first reflected object point P22′ on the second edge 204. In this embodiment, the object O2 forms an image P21 on the periphery member M3 in the first image. From the range of the image P21 on the third edge 206, the data processing module 27 can select any one point as the first object point P21′. In the first reflected image, the object O2 forms an image P22 on the periphery member M4 located at the fourth edge 208 because of the reflection of the first reflection device 24 or 24′ located at the second edge 204. From the range of the image P22, the data processing module 27 can select any one point as the first reflected object point P22′.

A first image-capturing point C1 can be defined corresponding to the position of the first image-capturing unit 22. In this embodiment, the first corner 200 is selected as the first image-capturing point C1. Based on the link relation between the first image-capturing point C1 and the first object point P21′, the data processing module 27 determines a first incident path S1. Based on the link relation between the first image-capturing point C1 and the first reflected object point P22′, the data processing module 27 determines a first reflected path R1. The path R1a in the first reflected path R1 is determined based on the link relation between the first image-capturing point C1 and the first reflected object point P22′. The path R1b in the first reflected path R1 is determined based on the path R1a and the reflection provided by the first reflection device 24 or 24′. The included angle between the normal line of the second edge 204 and the path R1a is the same as the included angle between the normal line of the second edge 204 and the path R1b. According to the cross point P′ of the first incident path S1 and the first reflected path R1, the data processing module 27 determines the relative position of the object O2 relative to the indication plane 20.

FIG. 12 illustrates how the object-detecting system 2 in one embodiment according to the invention detects the relative positions of the object O1 and object O2 relative to the indication plane 20. The capturing canters of the first image-capturing unit 22 and the second image-capturing unit 26 (for instance, the centers of the lenses) are selected as the image-capturing points when the object-detecting system 2 are determining the paths. With the descriptions related to FIG. 8 and FIG. 11, it can be understood that in the embodiment shown in FIG. 12, based on the images and reflected images captured by the first image-capturing unit 22, the incident path S2, the incident path S3, reflected path R2, and reflected path R3 can be determined. Based on the images and reflected images captured by the second image-capturing unit 26, the incident path S2′, the incident path S3′, reflected path R2′, and reflected path R3′ can be determined. Subsequently, it can be found that the incident path S2, the incident path S2′, reflected path R2, and reflected path R2′ have a cross point (or a cross region). The cross point P1 indicates that there is an object above the P1 position on the indication plane 20. Similarly, the cross point P2 of the incident path S3, the incident path S3′, reflected path R3, and reflected path R3′ can indicate there is another object above the P2 position on the indication plane 20. It can also be seen that the incident paths S3 and S2′ have a cross point P1′; the incident paths S2 and S3′ have a cross point P2′. The cross points P1′ and P2′ represent imaginary solutions instead real solutions such as the cross points P1 and P2. There is no object corresponding to the cross points P1′ and P2′.

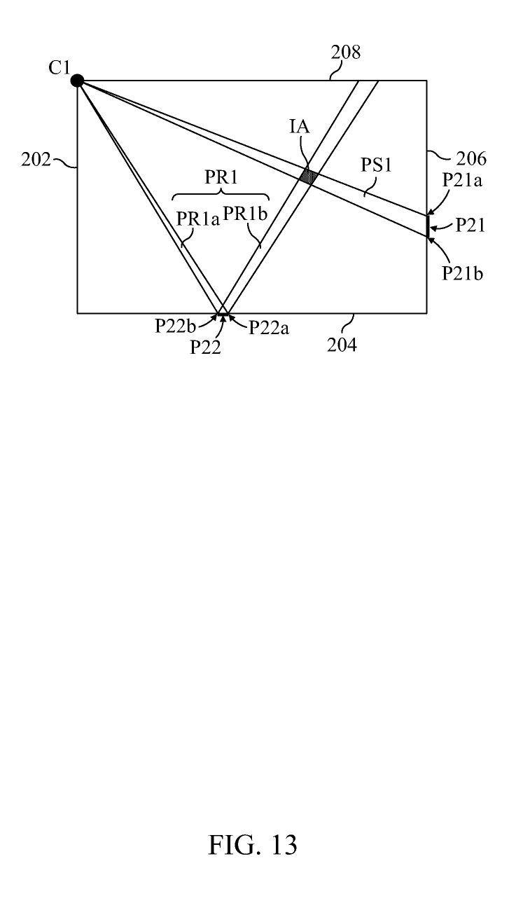

Please now refer to FIG. 8 and FIG. 13; how the object-detecting system 2 detects the object shape and the object area of the object O2 projected on the indication plane 20 is explained below. Based on the object image of object O2 in the first image, the data processing module 27 determines a first object point P21a and a second object point P21b on the third edge 206. The data processing module 27 also determines a first reflected object point P22a and a second reflected object point P22b on the second edge 204 based on first reflected image.

In this embodiment, the object O2 forms an image P21 on the periphery member M3 in the first image. From the range of the image P21 on the third edge 206, the data processing module 27 can select two different points as the first object point P21a and the second object point P21b. In the first reflected image, the object O2 forms an image P22 on the periphery member M4 located at the fourth edge 208 because of the reflection of the first reflection device 24 or 24′ located at the second edge 204. From the range of the image P22, the data processing module 27 can select two different points as the first reflected object point P22a and the second reflected object point P22b. In this embodiment, the two object points P21a and P21b are in the range of the image P21 formed on the third edge 206. The two reflected object points P22a and P22b are in the range of the image P22 formed on the second edge 204. The first corner 200 is selected as the first image-capturing point C1 defined by the first image-capturing unit 22.

Subsequently, based on the link relations respectively between the first image-capturing point C1 and the object points P21a and P21b, the data processing module 27 determines a first incident planar path PS1. Based on the link relations respectively between the first image-capturing point C1 and the reflected object points P22a and P22b, the data processing module 27 determines a first reflected planar path PR1. The first incident planar path PS1 can be defined by the planar region having edges formed by links respectively between the first image-capturing point C1 and the object points P21a and P21b. The first reflected planar path PR1 includes planar paths PR1a and PR1b. The planar path PR1a is determined based on the link relations respectively between the first image-capturing point C1 and the reflected object points P22a and P22b. In other words, the planar path PR1a can be defined by the planar region having edges formed by links respectively between the first image-capturing point C1 and the reflected object points P22a and P22b. The planar path PR1b is determined based on the planar path PR1a and the first reflection device 24 or 24′. The included angle between the normal line of the second edge 204 and the path from the point C1 to the point P22a is the same as the included angle between the normal line of the second edge 204 and the reflected path from the point P22a in the planar path PR1b. Similarly, the included angle between the normal line of the second edge 204 and the path from the point C1 to the point P22b is the same as the included angle between the normal line of the second edge 204 and the reflected path from the point P22b in the planar path PR1b.

Then, based on the shape and/or area of the region crossed by both the first incident planar path PS1 and the first reflected planar path PR1, the data processing module 27 determines the object shape and/or object area. The object shape can be represented by the shape of the cross region IA or other shapes inside or outside the cross region IA, for instance, the maximum inner rectangle/circle in the cross region IA or the minimum outer rectangle/circle outside the cross region IA. The object area can be represented by the area of the cross region IA or the area of other shapes inside or outside the cross region IA, for instance, the area of the maximum inner rectangle/circle in the cross region IA or the area of the minimum outer rectangle/circle outside the cross region IA. In actual applications, the data processing module 27 can also determine only the object shape or the object area according to practical requirements.

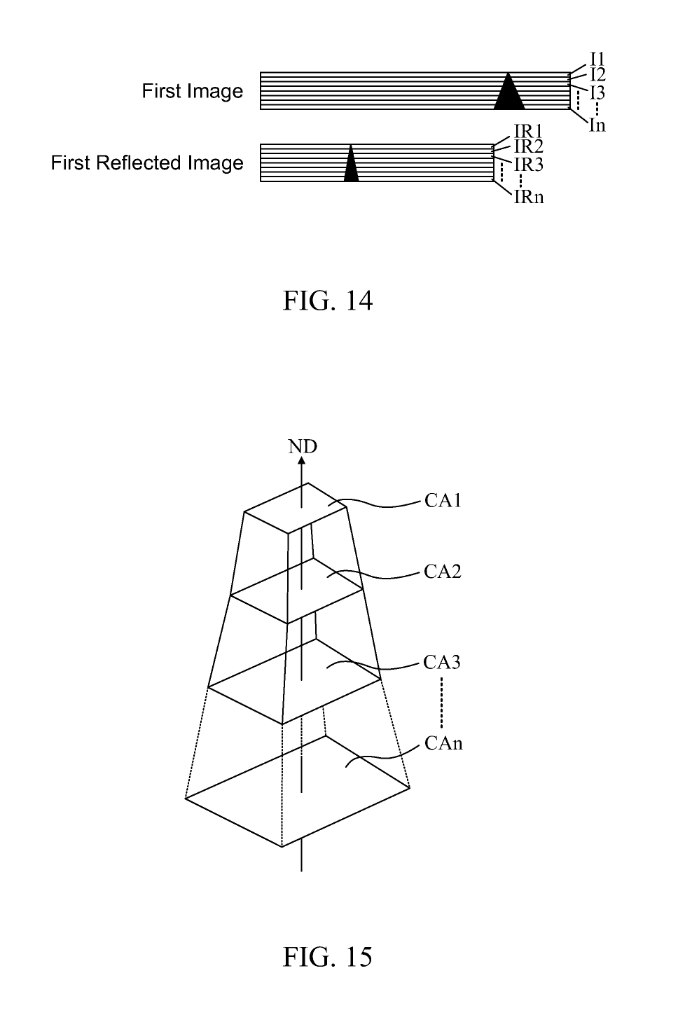

Besides FIG. 8 and FIG. 13, please also refer to FIG. 14 and FIG. 15; how the object-detecting system 2 detects the object three-dimensional shape and the object volume of the object O2 in the indication space S is explained below. The data processing module 27 respectively divides the first image and the first reflected image in FIG. 8 into plural first sub-images I1˜In and plural first reflected sub-images IR1˜IRn. With the method illustrated in the embodiments corresponding to FIG. 8 and FIG. 12, the data processing module 27 determines plural object shapes and plural object areas based on the sub-images I1˜In and corresponding sub-images IR1˜IRn. Then, the data processing module 27 sequentially piles the object shapes and the object areas along the normal line ND of the indication plane 20 (i.e. the direction perpendicular to the figure shown in FIG. 2A). The object three-dimensional shape and object volume of the object O2 can be accordingly determined.

In this embodiment, the first image is divided into n first sub-images I1˜In; the first reflected image is divided into n first reflected sub-images IR1˜IRn. Based on the n sets of first sub-image and first reflected image, n object shapes and n object areas CA1˜CAn are sequentially determined. Taking the representative points of the n object shapes (e.g. the centers of gravity) as centers, the object shapes and the object areas are sequentially piled along the normal line ND of the indication plane 20. According to the height of indication space S, the object three-dimensional shape and the object volume can then be determined. In actual applications, the data processing module 27 can also determine only the object three-dimensional shape or the object volume according to practical requirements.

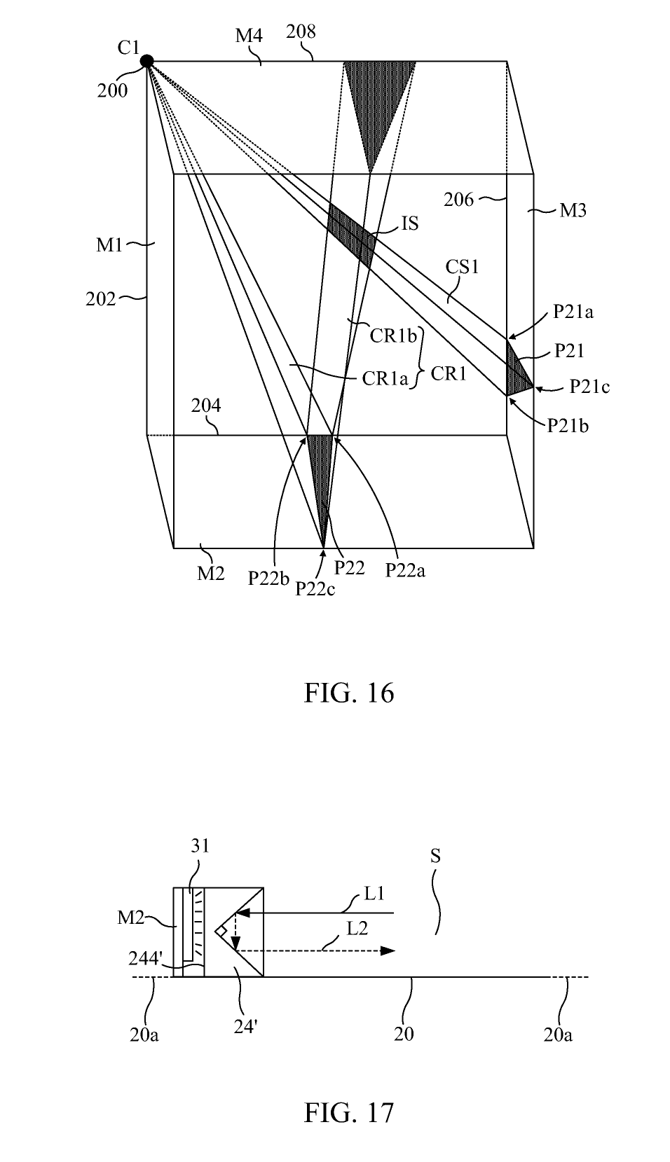

Please refer to FIG. 8 and FIG. 16; how the object-detecting system 2 detects the object three-dimensional shape and/or the object volume of the object O2 in the indication space S in another way is explained below. Based on the relative relation between the object O2 and the periphery member M2 and/or the relative relation between the object O2 and the periphery member M3 in the first image, the data processing module 27 determines a first object point P21a, a second object point P21b, and a third object point P21c. The data processing module 27 also determines a first reflected object point P22a, a second reflected object point P22b, and a third reflected object point P22c based on the relative relation between the object O2 and the periphery member M2 in the first reflected image.

In this embodiment, the object O2 forms an image P21 on the periphery member M3 in the first image. From the range of the image P21, the data processing module 27 can select three noncollinear points as the first object point P21a, the second object point P21b, and the third object point P21c. In the first reflected image, the object O2 forms an image P22 on the periphery member M2 by the reflection of the first reflection device 24 or 24′. From the range of the image P22, the data processing module 27 can select three noncollinear points as the first reflected object point P22a, the second reflected object point P22b, and the third reflected object point P22c. In this embodiment, the three object points P21a, P21b, and P21c are in the range of the image P21 formed on the periphery member M3. The three reflected object points P22a, P22b, and P22c are in the range of the image P22 formed on the periphery member M2. The first corner 200 is selected as the first image-capturing point C1 defined by the first image-capturing unit 22.

Subsequently, based on the link relations respectively between the first image-capturing point C1 and the object points P21a, P21b, and P21c, the data processing module 27 determines a first incident three-dimensional path CS1. Based on the link relations respectively between the first image-capturing point C1 and the reflected object points P22a, P22b, and P22c, the data processing module 27 determines a first reflected three-dimensional path CR1. The first incident three-dimensional path CS1 can be defined by the three-dimensional region having edges formed by links respectively between the first image-capturing point C1 and the object points P21a, P21b, and P21c. The first reflected three-dimensional path CR1 includes three-dimensional paths CR1a and CR1b. The three-dimensional path CR1a is determined based on the link relations respectively between the first image-capturing point C1 and the reflected object points P22a, P22b, and P22c. In other words, the three-dimensional path CR1a can be defined by the three-dimensional region having edges formed by links respectively between the first image-capturing point C1 and the reflected object points P22a, P22b, and P22c. The three-dimensional path CR1b is determined based on the three-dimensional path CR1a and the first reflection device 24 or 24′. As shown in FIG. 16, after being reflected by the first reflection device 24 or 24′, the three-dimensional path CR1a further forms the three-dimensional path CR1b that defines another three-dimensional region

Then, based on three-dimensional shape and/or volume of the space crossed by the first incident three-dimensional path CS1 and the first reflected three-dimensional path CR1, the data processing module 27 determines the object three-dimensional shape and/or the object volume. The object three-dimensional shape can be represented by the three-dimensional shape of the cross space IS or other three-dimensional shapes inside or outside the cross space IS, for instance, the maximum inner cube/spheroid in the cross space IS or the minimum outer cube/spheroid outside the cross space IS. The object volume can be represented directly by the volume of the cross space IS or other volume inside or outside the cross space IS, for instance, the volume of the maximum inner cube/spheroid in the cross space IS or the volume of the minimum outer cube/spheroid outside the cross space IS. In actual applications, the data processing module 27 can also determine only the object three-dimensional shape or the object volume according to practical requirements.

In the aforementioned embodiments, the images captured by the first image-capturing unit 22 are taken as examples. The operations related to the second image-capturing unit 26 are similar and accordingly not further described.

It should be noted that although the forms and locations of the light sources in FIG. 2A and FIG. 2B are different, the processes of determining the object information in the two systems are similar. Hence, the operations of the object-detecting system 3 can also be understood referring to FIG. 5A through FIG. 16. How the object-detecting system 3 determines the object three-dimensional shape and/or the object volume are not further described, either.

FIG. 17 illustrates an embodiment of how the first reflection device 24′ and the line light source 31 in the object-detecting system 3 are disposed. In this embodiment, the line light source 31 is disposed behind a back side 244′ of the first reflection device 24′. The first reflection device 24′ is a transflective lens. The light radiated from the line light source 31 can pass through the first reflection device 24′ from the back side 244′ toward the indication space S. On the contrary, the light in the indication space S radiating toward the first reflection device 24′ will be reflected by the first reflection device 24′. Therefore, the light radiated from the line light source 31 can pass through the first reflection device 24′ to illuminate the indication space S. At the same time, the first reflection device 24′ can from reflected images by reflecting lights from the indication space S. Taking the indication plane 20 as a reference plane, the first reflection device 24′ and the line light source 31 in this embodiment are relatively disposed beside each other instead of above and below. This arrangement can reduce the heights of the periphery members M1˜M4. The height of the object-detecting system 3 can accordingly be reduced.

In one embodiment according to the invention, the first image-capturing unit 22 and the second image-capturing unit 26 can respectively include an image sensor. The first image, the first reflected image, and the second reflected image can be formed on the image sensors. Practically, the image sensor can be an area sensor or a line sensor.

Besides paths determined based on directly captured images, the object-detecting system according to the invention also utilizes reflected paths determined based on images reflected by the first reflection device. Therefore, the object-detecting system can more accurately determine the relative position between the object and the indication plane, the object shape/area projected on the indication plane, and the object three-dimensional shape/volume in the indication space.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An object-detecting system, comprising:
a periphery member thereon defining an indication space and an indication plane in the indication space for an object to indicate a target position, there being a contrast relation between the periphery member and the object, the indication plane having a first edge, a second edge, a third edge and a fourth edge, the first edge and the fourth edge forming a first corner, the third edge and the fourth edge forming the second corner, the fourth edge being opposite to the second edge;
a first reflection device disposed on the second edge and on the periphery member;
a first image-capturing unit disposed adjacent to the first corner, the first image-capturing unit defining a first image-capturing point, capturing a first image of the indication space near a part of the periphery member corresponding to the second and third edges, and also capturing a first reflected image reflected by the first reflection device of the indication space near a part of the periphery member corresponding to the third and fourth edges;
a first point light source disposed adjacent to the first image-capturing unit for lighting the indication space; and
a data processing module electrically connected to the first image-capturing unit, the data processing module processing the first image and the first reflected image to determine object information relative to the object in the indication space.

2. The object-detecting system of claim 1, wherein the first reflection device is a plane mirror.

3. The object-detecting system of claim 1, wherein the first reflection device comprises a first reflection plane and a second reflection plane, the first reflection plane and the second reflection plane are substantially orthogonal and facing to the indication space, the indication space defines a extension plane, the first reflection plane defines a first extension plane, the second reflection plane defines a second extension plane, the first extension plane and the second extension plane substantially intersect with the extension plane at a 45 degree angle respectively.

4. The object-detecting system of claim 3, wherein the first reflection device is a prism.

5. The object-detecting system of claim 1, wherein the periphery member comprises a second reflection device substantially reflecting an incident light having a direction of travel along a direction opposite and parallel to the direction of travel, image of the object in the first image and the first reflected image appears on the second reflection device.

6. The object-detecting system of claim 5, wherein the second reflection device is a retro reflector.

7. The object-detecting system of claim 5, wherein the second reflection device is disposed on the first edge, the second edge, the third edge, and the fourth edge.

8. The object-detecting system of claim 1, wherein the object information comprises a relative position of the target position relative to the indication plane, the data processing module determines a first object point on the second edge and/or the third edge according to the image of the object in the first image, determines a first reflected object point on the second edge according to the image of the object in the first reflected image, determines a incident path according to the link relation between the first image-capturing point and the first object point, determines a first reflected path according the link relation between the first image-capturing point and the first reflected object point and the first reflection device, and determines the relative position according to an intersection point of the first incident path and the first reflected path.

9. The object-capturing system of the claim 1, wherein the object information comprises an object shape and/or an object area of the object projected on the indication plane, the data processing module determines a first object point and a second object point on the second edge and/or the third edge according to the image of the object in the first image, determines a first reflected object point and a second reflected object point on the second edge according to the image of the object in the first reflected image, determines a first incident planar path according to the link relation between the first image-capturing point and the first reflected object point, the link relation between the first image-capturing point and the second object point and the first reflection device, and determines the object shape and/or the object area according to the shape and/or the area of an intersection region of first incident planar path, and the first reflected planar path.

10. The object-capturing system of the claim 9, wherein the object information comprises an object three-dimensional shape and/or an object volume in the indication space, the data processing module respectively divides the first image and the first reflected image into a plurality of first sub-images and a plurality of first reflected sub-images, determines a plurality of sub-object three-dimensional shapes and/or a plurality of sub-object volumes, and determines the three-dimensional shape and/or an object volume by sequentially piling the plurality of sub-object three-dimensional shapes and/or the plurality of sub-object volumes along a normal direction of the indication plane.

11. The object-capturing system of the claim 1, wherein the object information comprises an object three-dimensional shape and/or an object volume in the indication space, the data processing module determines at least three object points on the part of the periphery member corresponding to the second edge and/or the third edge according to the image of the object in the first image, determines at least three reflected object points on the part of the periphery member corresponding to the second edge according to the image of the object in the first reflected image, determines a first incident three-dimensional path according to the respective link relations between the first image-capturing point and the at least three object points, determines a first reflected three-dimensional path according to the respective link relations between the first image-capturing point and the at least three reflected object points and the first reflection device, and determines the object three-dimensional shape and/or the object volume according to the three-dimensional shape and/or the volume of an intersection space of the first incident three-dimensional path and the first reflected three-dimensional path.

12. The object-detecting system of claim 1 further comprising a second image-capturing unit and a second point light source, the second image-capturing unit being electrically connected to the data processing module and disposed adjacent to the second corner, the second point light source being disposed adjacent to the second image-capturing unit, the second image-capturing unit capturing a second image of the indication space near a part of the periphery member corresponding to the first and second edges, and also capturing a second reflected image reflected by the first reflection device of the indication space near a part of the periphery member corresponding to the first and fourth edges, wherein the data processing module processing at least two among the first image, the first reflected image, the second image, and the second reflected image to determine object information.

13. An object-detecting system, comprising:
a periphery member thereon defining an indication space and an indication plane in the indication space for an object to indicate a target position, the periphery member comprising a line light source for lighting the indication space, the indication plane having a first edge, a second edge, a third edge, and a fourth edge, the first edge and the fourth edge forming a first corner, the third edge and the fourth edge forming the second corner, the fourth edge being opposite to the second edge;
a first reflection device disposed on the second edge;
a first image-capturing unit disposed adjacent to the first corner, the first image-capturing unit defining a first image-capturing point, capturing a first image of the indication space near a part of the periphery member corresponding to the second and third edges, and also capturing a first reflected image reflected by the first reflection device of the indication space near a part of the periphery member corresponding to the third and fourth edges; and
a data processing module electrically connected to the first image-capturing unit, the data processing module processing the first image and the first reflected image to determine object information relative to the object in the indication space.

14. The object-detecting system of claim 13, wherein the first reflection device is a plane mirror.

15. The object-detecting system of claim 13, wherein the first reflection device comprises a first reflection plane and a second reflection plane, the first reflection plane and the second reflection plane are substantially orthogonal and facing to the indication space, the indication space defines a extension plane, the first reflection plane defines an first extension plane, the second reflection plane defines a second extension plane, the first extension plane and the second extension plane substantially intersect with the extension plane at a 45 degree angle respectively.

16. The object-detecting system of claim 15, wherein the first reflection device is a prism.

17. The object-detecting system of claim 13, wherein the line light source is disposed on a back side of the first reflection device, the first reflection device is a transflective lens, so that the light from the line light source is capable of passing through the first reflection device toward the indication space from the back side of the first reflection device, and the light in the indication space is reflected as traveling to the first reflection device.

18. The object-detecting system of claim 13, wherein the line light source is disposed on the first edge, the second edge, the third edge, and the fourth edge.

19. The object-detecting system of claim 13, wherein the object information comprises a relative position of the target position relative to the indication plane, the data processing module determines a first object point on the second edge and/or the third edge according to the image of the object in the first image, determines a first reflected object point on the second edge according to the image of the object in the first reflected image, determines a incident path according to the link relation between the first image-capturing point and the first object point, determines a first reflected path according the link relation between the first image-capturing point and the first reflected object point and the first reflection device, and determines the relative position according to an intersection point of the first incident path and the first reflected path.

20. The object-capturing system of the claim 13, wherein the object information comprises an object shape and/or an object area of the object projected on the indication plane, the data processing module determines a first object point and a second object point on the second edge and/or the third edge according to the image of the object in the first image, determines a first reflected object point and a second reflected object point on the second edge according to the image of the object in the first reflected image, determines a first incident planar path according to the link relation between the first image-capturing point and the first reflected object point, the link relation between the first image-capturing point and the second object point and the first reflection device, and determines the object shape and/or the object area according to the shape and/or the area of an intersection region of first incident planar path, and the first reflected planar path.

21. The object-capturing system of the claim 20, wherein the object information comprises an object three-dimensional shape and/or an object volume in the indication space, the data processing module respectively divides the first image and the first reflected image into a plurality of first sub-images and a plurality of first reflected sub-images, determines a plurality of sub-object three-dimensional shapes and/or a plurality of sub-object volumes, and determines the three-dimensional shape and/or an object volume by sequentially piling the plurality of sub-object three-dimensional shapes and/or the plurality of sub-object volumes along a normal direction of the indication plane.

22. The object-capturing system of the claim 13, wherein the object information comprises an object three-dimensional shape and/or an object volume in the indication space, the data processing module determines at least three object points on the part of the periphery member corresponding to the second edge and/or the third edge according to the image of the object in the first image, determines at least three reflected object points on the part of the periphery member corresponding to the second edge according to the image of the object in the first reflected image, determines a first incident three-dimensional path according to the respective link relations between the first image-capturing point and the at least three object points, determines a first reflected three-dimensional path according to the respective link relations between the first image-capturing point and the at least three reflected object points and the first reflection device, and determines the object three-dimensional shape and/or the object volume according to the three-dimensional shape and/or the volume of an intersection space of the first incident three-dimensional path and the first reflected three-dimensional path.

23. The object-detecting system of claim 13 further comprising a second image-capturing unit electrically connected to the data processing module and disposed adjacent to the second corner, the second image-capturing unit capturing a second image of the indication space near a part of the periphery member corresponding to the first and second edges, and also capturing a second reflected image reflected by the first reflection device of the indication space near a part of the periphery member corresponding to the first and fourth edges, wherein the data processing module processing at least two among the first image, the first reflected image, the second image, and the second reflected image to determine object information.
